(19) United States
(12) Patent Application Publication
(10) Pub. No.: US 2006/0230397 A1
(43) Pub. Date: Oct. 12, 2006

(54) Method for third-party registration of software components

(76) Inventors: Johanna Madelaine Cook, Charlotte, NC (US); Erich Shannon Magee, Cary, NC (US); Hirenkumar Ishvarbhai Patel, Sanford, NC (US)

Correspondence Address: VAN LEEUWEN & VAN LEEUWEN, P.O. BOX 90609, AUSTIN, TX, 78709-0609, US

(21) Appl. No.: 11/093,665

(22) Filed: Mar. 30, 2005

(51) Int. Cl. G06F 9/445

(52) U.S. Cl. 717/174

(57) ABSTRACT

A method, computer program product, and data processing system for installing and registering software components as part of a unified solution, rather than simply as individual software components, are disclosed. According to a preferred embodiment, an installer supplies specific registration information as part of its overall installation process. This registration information overrides that used by the native component install technology to register the solution/component, as appropriate. In a preferred embodiment, the standard registration information provided by each software component's individual installer program is removed by an installation wrapper script and replaced by registration information that pertains to the installed solution as a whole. This registration scheme may just be characterized as a form of “late binding” of registration information.

### BACKGROUND OF THE INVENTION

1. Technical Field

The present invention relates generally to the field of software installation. More particularly, the present invention provides a method, computer program product, and system for registering a group of software components collectively.

2. Description of the Related Art

The current business environment favors marketing software as part of a solution rather than as stand-alone products. Under this approach, a “solution” may comprise a plurality of individual software products that are intended to be used together. For example, a computer software package for authoring and electronically filing patent applications may include a set of word processor macros for use in authoring an application, an imaging software package to convert the authored patent application into a form suitable for electronic filing (through the United States Patent and Trademark Office's Image File Wrapper system, for example), and a packing and validation engine for validating, packing, and filing the electronic application. Each of these programs may be produced by multiple vendors, but assembled into a single solution for delivery to a client.

This solution-based software marketing strategy does not necessarily fit well with current methods of software purchasing, licensing, and registration. Traditional methods dictate that each software component install and register itself. This runs counter to the solution-packaging approach where the registration should reflect the overall deliverable. This situation becomes even more complicated when the solution is packaged by a third-party provider using a variety of underlying components.

FIG. 1 is an activity diagram in Unified Modeling Language (UML) illustrating an install process for a software solution, as performed in accordance with existing art. The actions of different actors in the software installation process (e.g., different install scripts, etc.) are demarcated by swimlanes 102, 104, 106, and 108.

UML activity diagrams are typically divided visually into “swimlanes,” each separated from neighboring swimlanes by vertical solid lines on both sides. According the UML Specification, version 1.5, “swimlanes are used to organize responsibility for actions and subactivities.” Each swimlane represents a different actor within the system, and an action in an activity diagram is associated with a particular actor by being located within the swimlane corresponding to the appropriate actor. When UML is used to model software systems, each swimlane is usually associated with a different object or process in the system. The relative ordering of the swimlanes has no semantic significance. (See Object Management Group, OMG Unified Modeling Language Specification, version 1.5, March 2003, pp. 3-161-3-162).

Each of swimlanes 102, 104, 106, and 108 represents a different actor in the install process. Swimlane 102 represents an overall installer program or installation script. Swimlanes 104 and 106 represent individual installers for different software components or applications being installed as part of an overall solution. Swimlane 108 represents a system registry and/or one or more license or other registration files associated with the install process. For example, in the MICROSOFT WINDOWS operating system, swimlane 108 might represent the Windows system registry, which is a database of information regarding the various programs installed on a particular computer and their various settings. As one skilled in the art will recognize, various forms of system registries exist in the art, such as the component installation registries used in various versions of the Linux operating system (e.g., Red Hat Package Manager [RPM], Debian package tool, etc.), and the like.

Returning now to the specifics of FIG. 1, the installation process begins at start state 110, which leads to action 112, during which the overall solution/package installation program launches install programs/scripts for each of the underlying applications or software components being installed as part of the solution. Activity 112 is followed by fork symbol 114, which denotes that multiple installation activities are launched, possibly in a concurrent fashion (although concurrency is not strictly necessary). Turning now to the installer program for the first application being installed (swimlane 104), the application itself is first installed (action 116). Next, the application is registered in the system (action 118). This involves generating registry information (object 120) and adding this information to the system registry or to one or more license files (action 122 in swimlane 108). This registry information (object 120) may contain such information as a serial number for the product or a registration key for the product, so as to recognize the installed copy as any valid, licensed software product.

Similarly, with respect to the installer for application 2 (swimlane 106), the application itself is first installed (action 124). Next, the application is registered with the system (action 126). As with application 1, this involves generating registry information (object 128) and adding this information to the system registry or license files (action 130 in swimlane 108).

The overall install process ends with the termination of the overall package installer (swimlane 102), as denoted by join symbol 132 and termination state 134.

As can be seen from FIG. 1, there is a disconnection between the registry information installed with respect to application 1 and the registry information installed for application 2. This is because each of these applications is installed by its own installer program, which is independent of the other installer programs. These independent installer programs are only launched by the same overall installer program (swimlane 102) and otherwise operate independently.

What is needed, therefore, is a method for registering software components as a unified solution, rather than simply as individual components. The present invention provides a solution to these and other problems, and offers other advantages over previous solutions.

### SUMMARY

The present invention provides a method, computer program product, and data processing system for installing and registering software components as part of a unified solution, rather than simply as individual software components. According to a preferred embodiment, an installer supplies specific registration information as part of its overall installation process. This registration information overrides that used by the native component install technology to register the solution/component, as appropriate. In a preferred embodiment, the standard registration information provided by each software component's individual installer program is removed by an installation wrapper script and replaced by registration information that pertains to the installed solution as a whole. This registration scheme may just be characterized as a form of “late binding” of registration information.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is an activity diagram in Uniform Modeling Language (UML) illustrating an install process for a software solution, as performed in accordance with existing art;

FIG. 2 is a component diagram illustrating the relationships among the installer components in a preferred embodiment of the present invention;

FIG. 3 is an activity diagram that provides a detailed illustration of the operation of a preferred embodiment of the present invention; and

FIG. 4 is a block diagram of an information handling system capable of performing the computing operations described herein with respect to a preferred embodiment of the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

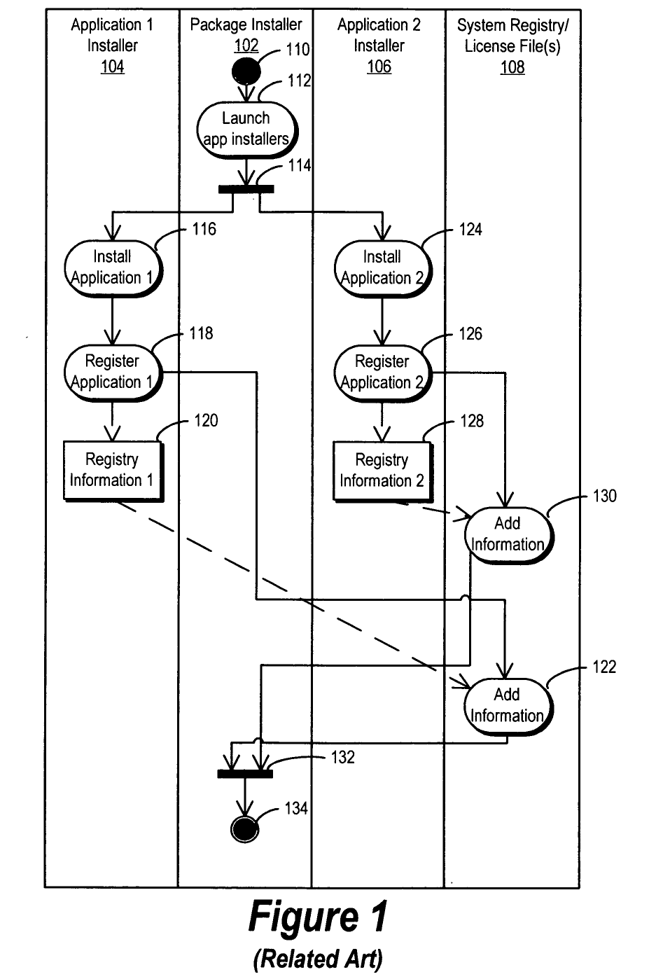

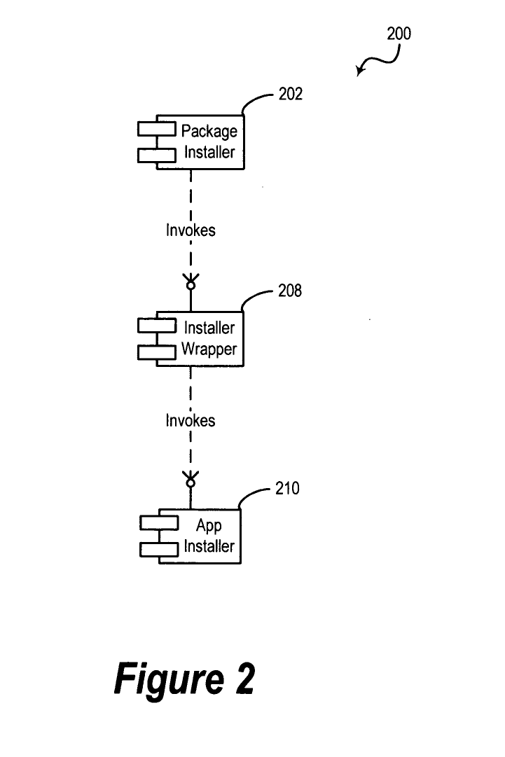

FIG. 2 is a component diagram illustrating the relationships among the installer components in a preferred embodiment of the present invention. Specifically, FIG. 2 illustrates the architecture for an installation system 200 for package of software components that are bundled together as a solution. Unlike the system described in FIG. 1, however, installation system 200 utilizes an intermediate wrapper component 208 to ensure that the software being installed is registered in the form of a package or collection of software components representing a unified software “solution.” Package installer component 202 is a single component that has the responsibility of initiating the installation of each of the individual software components/applications making up the software solution being installed. Package installer 202 performs this function by invoking instances of installer wrappers (installer wrapper component 208), each of which oversees the installation of a single software component or application to the system. Each installer wrapper component 208 invokes the “native” application installer 210 for the application that installer wrapper 208 is responsible for installing. Application installer 210 will, in most cases, install application-specific registration information, as if the application was being installed individually (and not as part of a packaged solution). However, installer wrapper component 208 has the responsibility to remove such application-specific registration information and replace that information with package/solution-specific registration information. Installer wrapper component 208 may also direct the installation of an individual application via application installer 210 by passing one or more options to application installer 210 (via a command line argument, for example) so as to custom tailor the installation of a given application to the solution of which it forms a part.

At this point, some observations about the meanings of some of the terms utilized in this description and the accompanying claims should be made. Firstly, the term “component” or “software component,” where it is used to denote something that is being installed, may refer to a application or other form of executable software program, but the term is not limited to programs, as such. “Component” should also be interpreted to refer to libraries (such as dynamically-linked libraries or “DLLs”), applets, scripts, and other items of executable code that are not, by themselves, programs. Further, the term “component” should also include items of data that are not executable code, but that may, nonetheless, be installed in a similar manner to executable programs. For instance, a dictionary of technical or legal terms for use with a spelling checker program is one example of a non-program component that may be installed for use as part of a software solution.

The term “native,” as used herein, also requires some explanation. In the document, the term “native,” as used in the context of a “native installer,” refers to the fact that the installer is that which is associated with the particular application or component being installed. As an illustrative example, in the context of a solution that is composed of multiple third-party components, the “native” installer of a given component is the installer that “comes with” that third-party component (i.e., the one supplied by the third-party that produced the component). The term “native” is used here to distinguish the installer supplied with the third-party component from installation software (such as wrapper component 208) that is supplied by the party that assembled the packaged solution. The term “native,” as used herein, should not be confused with the term “native code,” where that term is used to distinguish platform-independent code (such as source code in a portable programming language such as C) and code that is specific to a given computing platform.

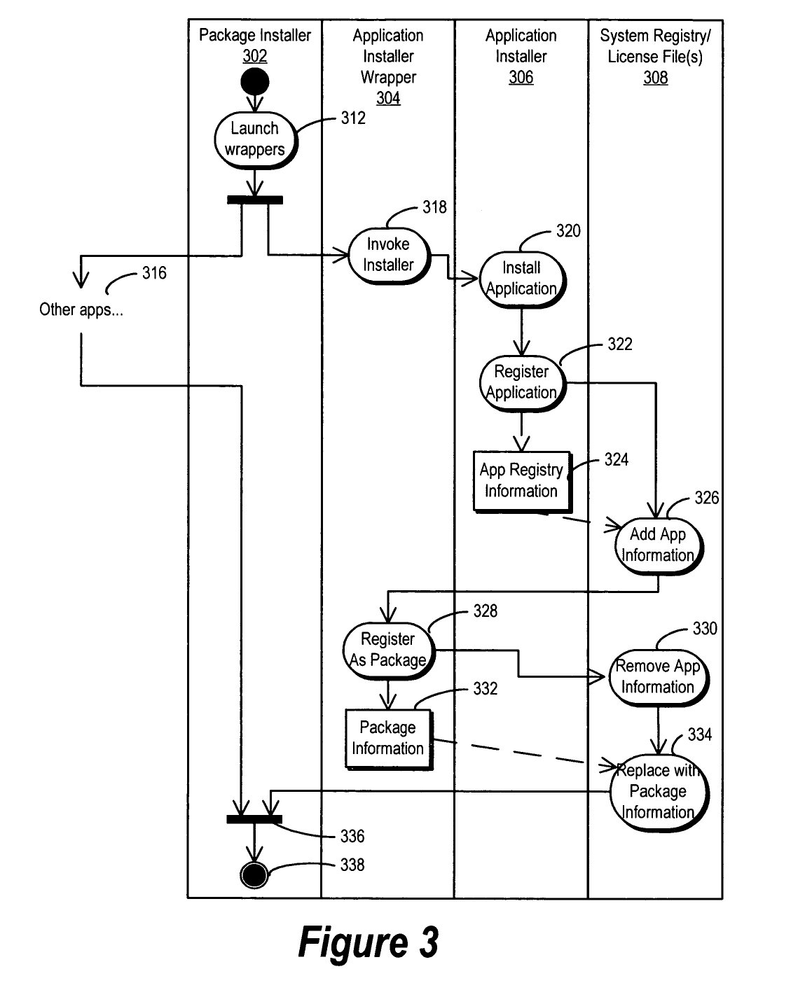

Returning now to the figures, FIG. 3 is an activity diagram that provides a more detailed illustration of the operation of a preferred embodiment of the present invention. Swimlanes 302, 304, 306, and 308 represent the various components utilized during the installation/registration process. The process begins in swimlane 302, which represents an overall package installer, corresponding to package installer component 202 in FIG. 2. At the beginning of the process (start state 310), application installer wrappers are launched (action 312). The fact that multiple installation wrappers are launched is denoted by fork symbol 314, which, like FIG. 1, should not be interpreted as necessitating concurrent execution of application installer wrappers (although such concurrent execution is certainly possible). In the example provided in FIG. 3, it is assumed that multiple application installer wrappers will be invoked. However, the detailed operation of only one application installer wrapper is depicted here in FIG. 3, for the sake of simplicity and conserving space. The fact that multiple application installer wrappers are invoked is symbolized by “other apps” symbol 316.

In this preferred embodiment, the first task of the application installer wrapper (swimlane 304) is to invoke the “native” application installer for the application that the application installer wrapper is to coordinate the installation of (action 318). The native application installer (swimlane 306) installs the actual application (action 320) and performs application-specific registration of that application (action 322), as if the application were being installed as a stand-alone application. This entails generating application-specific registration information (object 324) and adding that information to the system registry or one or more license files (action 326 in swimlane 308). Note that this is the normal operation of the native application installer. Thus, in order for a third-party application to be incorporated into a packaged solution, there is no need to actually modify the native application installer provided by that third-party vendor, as will become clearer below.

Once the native application installer has completed the normal installation process for a particular application, the application installer wrapper initiates a process of registering the now-installed application as being a component of the overall package being installed, rather than as a stand-alone in application (action 328). This entails first removing the application-specific registration information that was added to the system registry or license files in action 326 (action 330). New registration information corresponding to the packaged solution as a whole is generated by the application installer wrapper (object 332) and that information is used to replace the application-specific registration information that was added to the system registry or license files in action 326 (action 334). Finally, the process terminates at the overall package installer (swimlane 302), as denoted by join symbol 336 and termination state 338.

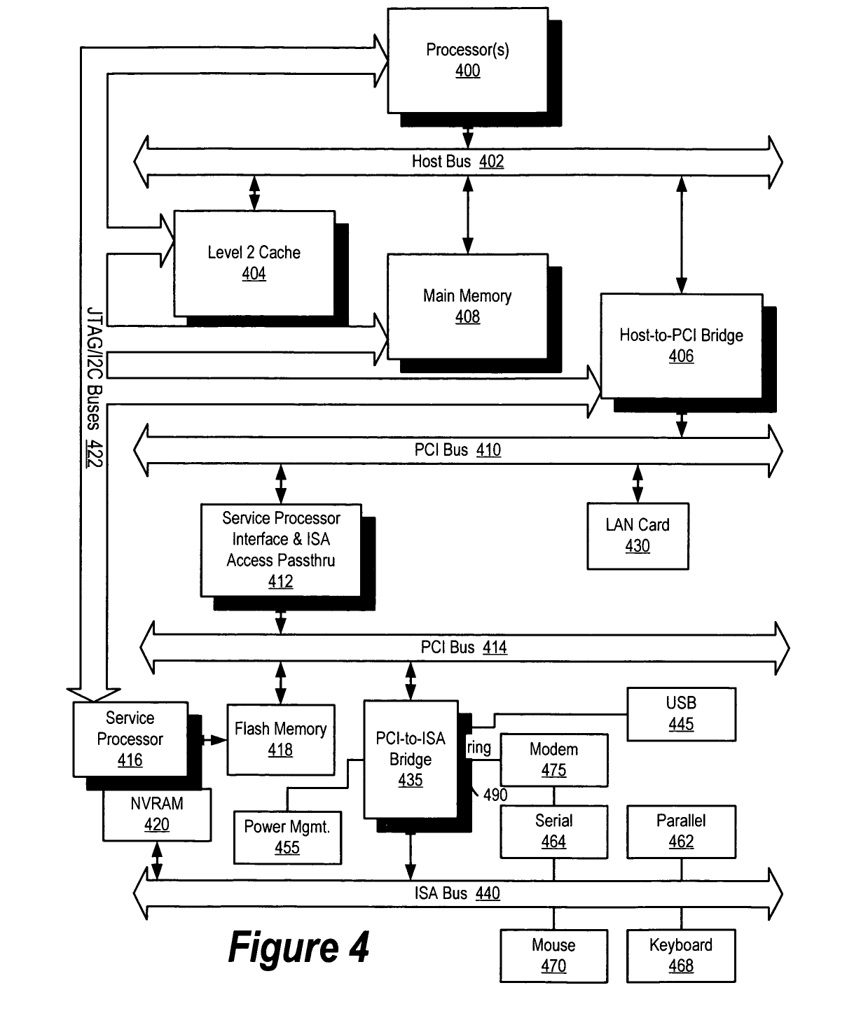

FIG. 4 illustrates information handling system 401 which is a simplified example of a computer system/client capable of performing the computing operations described herein with respect to a preferred embodiment of the present invention. Computer system 401 includes processor 400 which is coupled to host bus 402. A level two (L2) cache memory 404 is also coupled to host bus 402. Host-to-PCI bridge 406 is coupled to main memory 408, includes cache memory and main memory control functions, and provides bus control to handle transfers among PCI bus 410, processor 400, L2 cache 404, main memory 408, and host bus 402. Main memory 408 is coupled to Host-to-PCI bridge 406 as well as host bus 402. Devices used solely by host processor(s) 400, such as LAN card 430, are coupled to PCI bus 410. Service Processor Interface and ISA Access Pass-through 412 provides an interface between PCI bus 410 and PCI bus 414. In this manner, PCI bus 414 is insulated from PCI bus 410. Devices, such as flash memory 418, are coupled to PCI bus 414. In one implementation, flash memory 418 includes BIOS code that incorporates the necessary processor executable code for a variety of low-level system functions and system boot functions.

PCI bus 414 provides an interface for a variety of devices that are shared by host processor(s) 400 and Service Processor 416 including, for example, flash memory 418. PCI-to-ISA bridge 435 provides bus control to handle transfers between PCI bus 414 and ISA bus 440, universal serial bus (USB) functionality 445, power management functionality 455, and can include other functional elements not shown, such as a real-time clock (RTC), DMA control, interrupt support, and system management bus support. Nonvolatile RAM 420 is attached to ISA Bus 440. Service Processor 416 includes JTAG and I2C buses 422 for communication with processor(s) 400 during initialization steps. JTAG/I2C buses 422 are also coupled to L2 cache 404, Host-to-PCI bridge 406, and main memory 408 providing a communications path between the processor, the Service Processor, the L2 cache, the Host-to-PCI bridge, and the main memory. Service Processor 416 also has access to system power resources for powering down information handling device 401.

Peripheral devices and input/output (I/O) devices can be attached to various interfaces (e.g., parallel interface 462, serial interface 464, keyboard interface 468, and mouse interface 470 coupled to ISA bus 440. Alternatively, many I/O devices can be accommodated by a super I/O controller (not shown) attached to ISA bus 440.

In order to attach computer system 401 to another computer system to copy files over a network, LAN card 430 is coupled to PCI bus 410. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method comprising:
installing a software component in a data processing system, wherein the software component is one of a plurality of software components making up a packaged solution; and
recording, in the data processing system, registration information that is associated with the packaged solution.

2. The method of claim 1, further comprising:
removing, from the data processing system, registration information that is specific to the software component.

3. The method of claim 2, wherein the registration information that is associated with the packaged solution replaces the registration information that is specific to the software component.

4. The method of claim 1, wherein at least a portion of the registration information that is associated with the packaged solution is recorded in a system registry associated with an operating system residing on the data processing system.

5. The method of claim 1, wherein at least a portion of the registration information that is associated with the packaged solution is recorded in a license file.

6. The method of claim 1, wherein the software component is installed by executing a native installer for the software component.

7. The method of claim 6, wherein the native installer records, in the data process system, registration information that is specific to the software component, and wherein recording the registration information that is associated with the packaged solution includes replacing the registration information that is specific to the software component with the registration information that is associated with the packaged solution.

8. The method of claim 7, wherein said replacing is performed by an installation wrapper component subsequent to the installation wrapper's invoking the native installer.

9. A computer-implemented method comprising:
executing a native installer for a software component, wherein the native installer installs the software component in a data processing system, wherein the software component is one of a plurality of software components making up a packaged solution, and wherein the native installer records registration information that is specific to the software component; and
executing an installation wrapper, wherein the installation wrapper removes the registration information that is specific to the software component and replaces said registration information with registration information that is associated with the packaged solution as a whole.

10. A computer program product in a computer readable medium, comprising functional descriptive material that, when executed by a data processing system, causes the data processing system to perform actions that include:
installing a software component in the data processing system, wherein the software component is one of a plurality of software components making up a packaged solution; and
recording, in the data processing system, registration information that is associated with the packaged solution.

11. The computer program product of claim 10, comprising additional functional descriptive material that, when executed by the data processing system, causes the data processing system to perform actions that include:
removing, from the data processing system, registration information that is specific to the software component.

12. The computer program product of claim 11, wherein the registration information that is associated with the packaged solution replaces the registration information that is specific to the software component.

13. The computer program product of claim 10, wherein at least a portion of the registration information that is associated with the packaged solution is recorded in a system registry associated with an operating system residing on the data processing system.

14. The computer program product of claim 10, wherein at least a portion of the registration information that is associated with the packaged solution is recorded in a license file.

15. The computer program product of claim 10, wherein the software component is installed by executing a native installer for the software component.

16. The computer program product of claim 15, wherein the native installer records, in the data processing system, registration information that is specific to the software component, and wherein recording the registration information that is associated with the packaged solution includes replacing the registration information that is specific to the software component with the registration information that is associated with the packaged solution.

17. The computer program product of claim 16, wherein said replacing is performed by an installation wrapper component subsequent to the installation wrapper's invoking the native installer.

18. A data processing system comprising:
at least one processor;
at least one memory associated with the at least one processor;
storage associated with the at least one processor; and
a set of instructions contained within the at least one memory, wherein the at least one processor executes the set of instructions in order to perform actions of:
installing a software component in the storage, wherein the software component is one of a plurality of software components making up a packaged solution; and
recording, in the storage, registration information that is associated with the packaged solution.

19. The data processing system of claim 18, wherein the set of instructions includes instructions that direct the processor to remove, from the storage, registration information that is specific to the software component.

20. The data processing system of claim 18, wherein at least a portion of the registration information that is associated with the packaged solution is recorded in a system registry associated with an operating system residing in the storage.
